(19) United States
(12) Patent Application Publication
(10) Pub. No.: US 2009/0298499 A1
(43) Pub. Date: Dec. 3, 2009

(54) MOBILE TELECOMMUNICATION SERVICE SYSTEM AND METHOD USING PUBLIC FREQUENCY

(75) Inventors: SEONG-RYONG CHOI, Seoul (KR); YEON-SOO PARK, Seoul (KR); KI-HWAN LI, Seoul (KR); PYOUNG-KANG SHIM, Seoul (KR); DAE-HOON KANG, Cheonan-si (KR)

Correspondence Address: CANTOR COLBURN, LLP, 20 Church Street, 22nd Floor, Hartford, CT, 06103, US

(73) Assignee: National Emergency Management Agency of Republic of Korea, Seoul (KR)

(21) Appl. No.: 12/139,145

(22) Filed: Jun. 13, 2008

(30) Foreign Application Priority Data
May 29, 2008 (KR) 10-2008-0050008

(51) Int. Cl. H04Q 7/20

(52) U.S. Cl. 455/435.1

(57) ABSTRACT

Mobile telecommunication service system and method using a public frequency are provided. The method includes receiving a call connection request for a certain recipient from a mobile communication terminal; and connecting a radio interval between the mobile communication terminal and a Base station Transceiver Subsystem (BTS) of a call connection interval of the mobile communication terminal and the certain recipient, using a public frequency band. Accordingly, it is possible to stably connect the call to the public institution in case of the emergency or the public operation. By raising the utilization of the limited frequency resources, the insufficient frequency in the private mobile telecommunication can be addressed. The public institutions provide the public frequency to the private telecommunication companies and use the mobile communication service for free or at a low cost in return.

### PRIORITY

This application claims the benefit under 35 U.S.C. §119(a) of a Korean patent application filed in the Korean Intellectual Property Office on May 29, 2008 and assigned Serial No. 2008-0050008, the entire disclosure of which is hereby incorporated by reference.

### BACKGROUND OF THE INVENTION

1. Field of the Invention

The present invention relates generally to mobile telecommunication service system and method using a public frequency. More particularly, the present invention relates to a system and a method for providing a mobile telecommunication service using a public frequency band allocated to a public institution for public operations.

2. Description of the Related Art

Mobile telecommunication companies are providing a mobile telecommunication service using specific frequency bands allocated. When phone calls for saying hello to each other abruptly increase in holidays such as year-end, Christmas eve, New Year's day, and Thanksgiving day, or when mobile telecommunication subscribes are gathered together more than usual in a specific area such as large-scale sport event area, the mobile telecommunication companies are subject to a limitation in servicing the mobile telecommunication users using only the commercially allocated frequency bands. Particularly, when an accident such as earthquake, fire, and collapse occurs in a specific region, the mobile telecommunications for asking for the safety of family members or friends abruptly increase. In this situation, the out-of-service can be caused in the corresponding region. In addition, it is highly likely to fail the mobile phone call connections to the public institutions for reporting of the accident, asking for a rescue, and performing the rescue operations, which have the highest priority. Data communication services provided by the mobile telecommunication companies, such as game downloading or video streaming to mobile telecommunication terminals, are increasing. In this respect, it is quite hard for the mobile telecommunication companies to fully handle the increasing data communication services merely using the commercially allocated frequency bands.

Public institutions are allocated certain frequency bands for their public operations. Yet, it requires much cost for the public institution to construct and maintain a wireless communication system for using the public frequency band. Employers of the public institution need to possess a communication terminal for a private mobile telecommunication service and a communication terminal for the communication network service of the public institution, which decreases the activity.

Since the communication demand in the public operations does not yet exceed the frequency resources allocated to the public institution, what is needed is a method for using the communication system of the private mobile telecommunication service provider over the public frequency band in case of emergency or public operations.

### SUMMARY OF THE INVENTION

An aspect of the present invention is to address at least the above mentioned problems and/or disadvantages and to provide at least the advantages described below. Accordingly, an aspect of the present invention is to provide a system and a method for providing a mobile telecommunication service using a public frequency band allocated to a public institution for public operations.

The above aspects are achieved by providing a mobile telecommunication service method using a public frequency. The method includes receiving a call connection request for a certain recipient from a mobile communication terminal; and connecting a radio interval between the mobile communication terminal and a Base station Transceiver Subsystem (BTS) of a call connection interval of the mobile communication terminal and the certain recipient, using a public frequency band.

The mobile telecommunication service may further include authorizing the mobile communication terminal to use the public frequency band. When the authorization fails, the radio interval of the mobile communication terminal and the BTS may be connected using a commercial frequency band.

The authorization may be performed when the mobile communication terminal is registered for public operations or when the recipient is a public institution.

The call connection request of the mobile communication terminal may be made through the public frequency band.

The call connection request through the public frequency band may be made when the mobile communication terminal is registered for public operations, when an emergency button of the mobile communication terminal is selected, or when the recipient is a public institution.

The mobile telecommunication service method may further include charging a fee for the call using the public frequency band for nothing or at a preset discount rate.

According to another aspect of the present invention, a mobile telecommunication service method using a public frequency includes receiving a call connection request for a mobile communication terminal from a certain sender; and connecting a radio interval between the mobile communication terminal and a Base station Transceiver Subsystem (BTS) of a call connection interval of the mobile communication terminal and the sender, using the public frequency band.

The mobile telecommunication service method may further include authorizing the mobile communication terminal to use the public frequency band. When the authorization fails, the radio interval of the mobile communication terminal and the BTS may be connected using a commercial frequency band.

The authorization may be performed when the mobile communication terminal is registered for public operations or when the sender is a public institution.

The mobile telecommunication service method may further include charging a fee for the call using the public frequency band for nothing or at a preset discount rate.

According to yet another aspect of the present invention, a mobile telecommunication service method using a public frequency includes receiving one of a Short Messaging Service (SMS) message and a Multimedia Messaging Service (MMS) message from a mobile communication terminal over a public frequency band; and forwarding the received message to a recipient.

The mobile telecommunication service method may further include receiving a transmission request for one of an SMS message and an MMS message destined for a mobile communication terminal; and sending the message to the mobile communication terminal over the public frequency band when the mobile communication terminal is registered for public operations.

According to still another aspect of the present invention, a mobile telecommunication service system using a public frequency includes a Base station Transceiver Subsystem (BTS) for wirelessly communicating with a mobile communication terminal; and a Mobile Switching Center (MSC) for, when receiving a call connection request for a certain recipient from the mobile communication terminal, controlling to use an allocable channel of a public frequency band as a radio interval between the mobile communication terminal and the BTS of a call connection interval of the mobile communication terminal and the recipient.

The mobile telecommunication service system may further include an authorizing means for authorizing the mobile communication terminal to use the public frequency band. When the authorization fails, the MSC may control to use an allocable channel of a commercial frequency band as the radio interval between the mobile communication terminal and the BTS.

The call connection request of the mobile communication terminal may be made over the public frequency band.

The call connection request through the public frequency band may be made when the mobile communication terminal is registered for public operations, when an emergency button of the mobile communication terminal is selected, or when the recipient is a public institution.

When receiving a call connection request for the mobile communication terminal from a certain sender, the MSC may control to use an allocable channel of a public frequency band as a radio interval between the mobile communication terminal and the BTS.

The authorization may be performed when the mobile communication terminal is registered for public operations, when the sender is a public institution, or when the recipient is a public institution.

The BTS may receive one of a Short Messaging Service (SMS) message and a Multimedia Messaging Service (MMS) message from the mobile communication terminal over a public frequency band, and the MSC may forward the received message to a recipient.

The MSC may receive a transmission request for one of an SMS message and an MMS message destined for a mobile communication terminal, and the BTS may send the message to the mobile communication terminal over the public frequency band when the mobile communication terminal is registered for public operations.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will become more apparent from the following detailed description taken in conjunction with the accompanying drawings, in which:

FIG. 1 is a block diagram of a mobile telecommunication service system using a public frequency_according to an exemplary embodiment of the present invention;

FIG. 2 is a detailed block diagram of a mobile communication terminal of FIG. 1;

FIG. 3 is a flowchart of a method for connecting a call to a public institution communication device using a public frequency band in the mobile communication terminal according to an exemplary embodiment of the present invention; and

FIG. 4 is a flowchart of a method for connecting a call when the mobile communication terminal used for public operations is employed as a recipient terminal according to an exemplary embodiment of the present invention.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

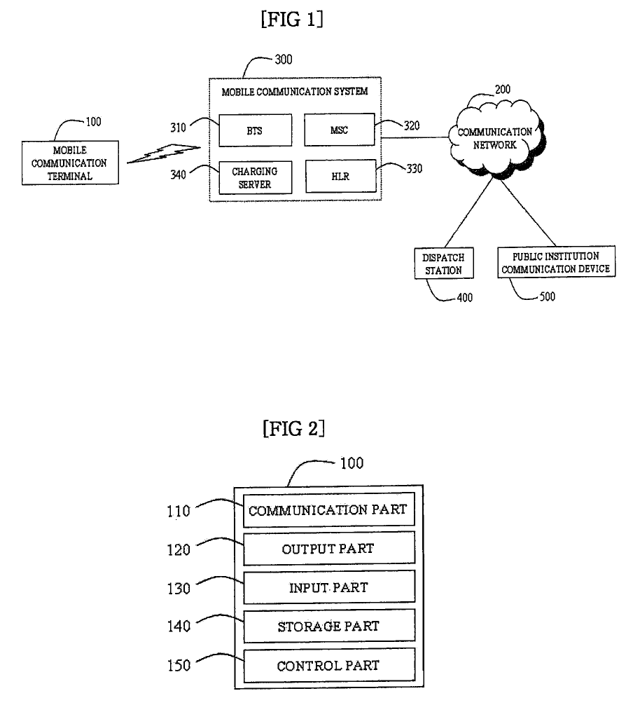

FIG. 1 is a block diagram of a mobile telecommunication service system using a public frequency according to an exemplary embodiment of the present invention.

In FIG. 1, the mobile telecommunication service system using the public frequency includes a mobile communication terminal 100, a mobile communication system 300, a dispatch station 400, and a public institution communication device 500. Herein, the mobile communication terminal 100 wirelessly communicates with the mobile communication system 300. The mobile communication system 300, the dispatch station 400, and the public institution communication device 500 are interconnected over a communication network 300.

The mobile communication system 300 can include a Base station Transceiver Subsystem (BTS) 310, a Base Station Controller (BSC) (not shown), a Mobile Switching Center (MSC) 320, a Visitor Location Register (VLR) (not shown), a Home Location Register (HLR) 330, a Short Message Service Center (SMSC) (not shown), a Multimedia Message Service Center (MMSC) (not shown), a WAP gateway (not shown), and a charging server 340. The mobile communication system 300 can interface voice communications or data communications between the mobile communication terminal 100 and another mobile communication terminal (not shown), a wired terminal (not shown), or the public institution communication device 500.

The BTS 310 is responsible for radio communications with the mobile communication terminal 100. Particularly, the BTS 310 can wirelessly communicate with the mobile communication terminal 100 by selectively using a commercial frequency band and a public frequency band under control of the BSC (not shown). Herein, the commercial frequency band is a frequency band commercially allocated to a mobile communication company which operates the mobile communication system 300, and the public frequency band is a frequency band allocated to a public institution for fire/police communications. For example, in South Korea, 800 MHz, 1.7-1.8 GHz, and 2.1 GHz bands are used as the commercial frequency bands for cellular communications, PCS, and WCDMA service, and 449 MHz, 458 Mhz, and 150 MHz are used as the public frequency bands for public operations such as fire communications, emergent medical operation, and forest fire extinction.

The BSC (not shown) is positioned between the BTS 310 and the MSC 320, to manage and control a plurality of BTSs 310. Particularly, upon receiving a public frequency channel allocation command from the MSC 320, the BSC (not shown) can control the BTS 310 to communicate using an allocable channel of the public frequency band between the BTS 310 and the mobile communication terminal 100. When receiving a commercial frequency channel allocation command, the BSC (not shown) can control the BTS 310 to communicate using an allocable channel of the commercial frequency band when there is no specific frequency channel allocation command, the BSC can allocate the commercial frequency channel to the BTS 310 to communicate with the mobile communication terminal 100 over the commercial frequency channel.

The MSC 320 controls voice call and various additional services, and establishes a speech path by connecting to a foreign network. Particularly, when receiving a call connection request from the mobile communication terminal 100 for a certain recipient, the MSC 320 can request the HLR 330 to perform the authorization relating to whether the mobile communication terminal 100 can use the public frequency band. When the authorization succeeds, the MSC 320 can send a public frequency channel allocation command to the BSC (not shown) to use the public frequency band for the communications between the mobile communication terminal 100 and the BTS 310. When the authorization fails, the MSC 320 can send a commercial frequency channel allocation command to the BSC (not shown) to use the commercial frequency band for the communications between the mobile communication terminal 100 and the BTS 310. The MSC 320 can establish a speech path to connect the call between the mobile communication terminal 100 and the recipient.

The MSC 320 can perform the above-mentioned functions when receiving a call connection request from a certain sender for the mobile communication terminal 100.

The HLR 330 registers a home location of the mobile communication terminal 100. The HLR 330 can provide the location information of the mobile communication terminal 100 to the components of the mobile communication system 300. The HLR 330 also provides information of a mobile communication service subscriber and registration information of additional service per subscriber. Particularly, the HLR 330 can store information relating to the mobile communication terminal 100 registered for the public operations. The HLR 330 can perform the authorization relating to whether the mobile communication terminal 100 can use the public frequency band. That is, the HLR 330 can authorize to use the public frequency depending on whether the recipient is the public institution or the mobile communication terminal 100 registered for the public operations, or the sender is the public institution or the mobile communication terminal 100 registered for the public operations.

The charging server 340 charges a fee of the call and the message per user based on the usage. Particularly, when the sender is the public institution communication device 500 or the mobile communication terminal 100 for the public operations and uses the mobile communication service such as voice call or message delivery using the public frequency band, the charging server 340 can charge the fee for free or based on a preset discount rate. Notably, in case of charging a call fee to the sender terminal and the recipient terminal, when the recipient terminal uses the public frequency band, similar to the sender terminal, the charging server 340 can charge the fee for free or apply the preset discount rate.

The mobile communication system 300 can support the communications of the mobile communication terminal 100 with not only one correspondent but also multiple parties. For instance, when the simultaneous call for a preset group is requested in the mobile communication terminal 100, the mobile communication system 300 can connect the calls to enable the simultaneous callings in the corresponding group. For doing so, the HLR 330 can store the group information for the simultaneous call. Alternatively, the intended group information for the simultaneous call can be provided to the mobile communication system 300 when the call connection is requested in the mobile communication terminal 100.

The mobile communication terminal 100 can communicate with the BTS 310 by selectively using the commercial frequency band and the public frequency band. The mobile communication terminal 100 can communicate with the BTS 310 using the public frequency band in case of the public operations or the emergency, and using the commercial frequency band in other cases, which will be described in more detail.

The public institution communication device 500 is a communication device operated by the public institution such as fire and emergency management agency or police agency. The public institution communication device 500 can communicate with the mobile communication terminal 100 and the dispatch station 400 over the communication network 200. When being reported of the public operation from the mobile communication terminal 100, the public institution communication device 500 can forward the report to a communication terminal (not shown) of the corresponding person in charge. Particularly, when being reported of an emergency from the mobile communication terminal 100, the public institution communication device 500 can transmit a dispatch command by locating the dispatch station 400 near the very scene or the mobile communication terminal 100 of a rescue worker. Herein, the dispatch command can include a phone number of the communication terminal of the parties to the accident. Using the mobile communication terminal 100, the rescue worker can perform the emergent communications with the parties to the accident. For the convenience of the rescue worker, it is preferred that the dispatch command is in the form of a short message and that the phone number of the communication terminal of the parties to the accident is inserted to the short message as a callback URL. Accordingly, by confirming the corresponding message and pressing a call button, the rescue worker can talk with the parties to the accident over the phone.

The dispatch station 400 is a communication device operated by the public institution positioned in regions, such as fire station or police station. The dispatch station 400 is connected to the public institution communication device 500 over the communication network 200 to exchange various information. Particularly, upon receiving the dispatch command from the public institution communication device 500, the dispatch station 400 displays its contents in a display so that the rescue workers such as firemen and police officers are dispatched to the scene of the accident.

The communication network 200 can be any one of a Local Area Network (LAN), a Metropolitan Area Network (MAN), a Wide Area Network (WAN), Internet, and a mobile communication network. Its communication scheme can be wired or wireless.

Now, the mobile communication terminal 100 is explained in more detail by referring to FIG. 2.

FIG. 2 is a detailed block diagram of the mobile communication terminal 100 of FIG. 1.

The mobile communication terminal 100 of FIG. 2 can include a communication part 110, an output part 120, an input part 130, a storage part 140, and a control part 150.

The communication part 110 transmits and receives the radio signal to and from the BTS 310 over the air, and modulates and demodulates the signal. Particularly, the communication part 110 can include an antenna (not shown) and a duplexer (not shown) to support both or either of the commercial frequency band and the public frequency band. The dual-band or multi-band function of the mobile communication terminal for supporting the different frequency bands are well-known in the art and thus shall not be further illustrated.

The output part 120 can include a display means such as LCD panel, a speaker for producing a sound, and a vibrating means for generating vibration. Under the control of the control part 150, the output part 120 outputs information in relation to the operations of the mobile communication terminal 100, and various information received from outside.

The input part 130 can include a key pad or a touch pad having number keys, function keys, and character keys, and an input means such as a microphone for receiving a sound. The input part 130 forwards the command received from the user to the control part 150. According to the present invention, the input part 130 can include an emergency button (not shown).

The storage part 140 stores various data and programs required for the operations of the mobile communication terminal 100, and provides the stored data and programs as requested by the control part 150. Particularly, the storage part 140 can store phone numbers of public institutions (e.g., 112 and 119), subordinate offices, superior authorities, and related agencies, and phone numbers of mobile communication terminals for the public operations belonging to the institution. The storage part 140 can group the stored phone numbers based on the institution or the type. The storage part 140 can store an emergency phone number preset to connect the call when the emergency button is selected. Herein, the emergency phone number can be an ID number corresponding to the public institution communication device 500. The storage part 140 stores setup information relating to whether to prefer the public frequency band to the commercial frequency band in the communications with the BTS 310.

The control part 150 controls the overall operation of the mobile communication terminal 100. Specifically, the control part 150 can control the communication part 110 to transmit and receive the signals to and from the BTS 310 using the public frequency band in case of the emergency or the public operations, or using the commercial frequency band in other cases.

The determination on the emergency or the public operations can be made in various manners. For instance, when the user presses the emergency button or inputs the phone number and requests the call connection or the message delivery, the control part 150 can determine the emergency or the public operation. The user may request the call connection or the message delivery by selecting one of the phone numbers grouped and stored based on the institution or the type, or by selecting the intended group to be connected. When the mobile communication terminal 100 is used by a person concerned with the public operations such as police officer, fireman, or subject to be cared, the control part 150 may prefer the public frequency band to the commercial frequency band in the communications. The mobile communication terminal 100 may be installed around an object of the danger/safety supervision, rather than being carried by the person, so as to report the emergency directly to the relevant public institution such as fire station.

The mobile communication terminal 100 can include a separate button or designate a speed dial for the rapid call connection or message delivery. When the user presses the emergency button, the mobile communication terminal 100 and the mobile communication system 300 can transmit the subscriber information and the location information of the mobile communication terminal 100 for the rapid rescue operation.

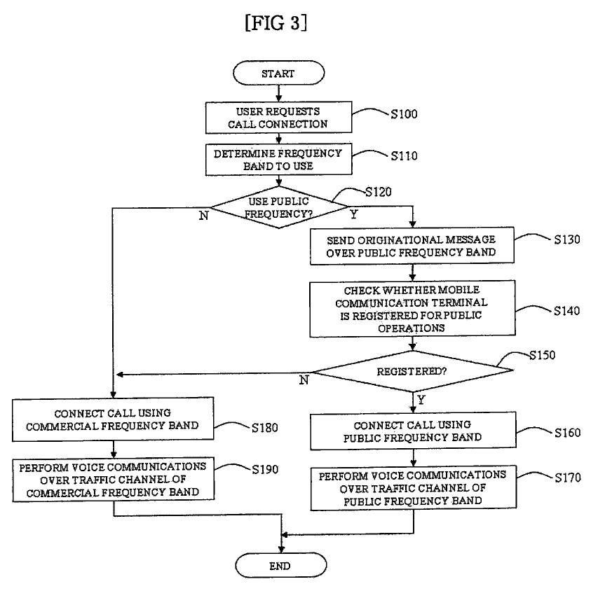

Now, the descriptions explain a method for connecting the call to the public institution communication device using the public frequency band in the mobile communication terminal by referring to FIG. 3.

When the user requests the call connection (S100), the mobile communication terminal 100 determines whether to use the public frequency band or the commercial frequency band to send an originational message to the BTS 310 (S110). More specifically, when the user inputs the phone number corresponding to the public institution communication device 500 or selects the emergency button, the mobile communication terminal 100 can determine to send the originational message using the public frequency band.

When determining to use the public frequency band (S120-Y), the mobile communication terminal 100 can send the originational message to the BTS 310 over an access channel of the public frequency band (S130).

Receiving an originational message from the mobile communication terminal 100 over the access channel of the public frequency band, the mobile communication system 300 checks the current location of the corresponding mobile communication terminal 100 and whether the mobile communication terminal 100 is registered for the public operation, by referring to the HLR 330 (S140).

When the mobile communication terminal 100 is registered for the public operations (S150-Y), the MSC 320 transmits the public frequency allocation command to the BSC (not shown). Next, the BSC (not shown) controls the BTS 310 to communicate using the allocable channel of the public frequency band. The BTS 310 allocates a traffic channel (the downlink channel and the uplink channel) of the public frequency band to the corresponding mobile communication terminal 100.

The MSC 320 performs the remaining call connection procedure and connects the call between the public institution communication device 500 and the mobile communication terminal 100 (S160). How the mobile communication system 300 connects the call to the recipient terminal after receiving the originational message from the sender terminal is well known to one in the art and shall not be further explained.

The BTS 310 performs the voice communications with the mobile communication terminal 100 over the traffic channel of the public frequency band (S170). Thus, the user of the mobile communication terminal 100 can have the voice communications with the manager of the public institution communication device 500.

By contrast, when determining to use the commercial frequency band (S120-N), the mobile communication terminal 100 and the mobile communication system 300 connect the call through the access channel, a paging channel, and the traffic channel of the commercial frequency band (S180). When the call is connected, the mobile communication terminal 100 and the BTS 310 can perform the voice communications over the traffic channel of the commercial frequency band (S190).

When the mobile communication terminal 100 is not registered for the public operations (S150-N), the mobile communication terminal 100 and the mobile communication system 300 perform the call connection procedure using the commercial frequency band (S180) and conduct the voice communications over the traffic channel of the commercial frequency band (S190).

While the voice communications are conducted between the mobile communication terminal and the BTS using the public frequency band in FIG. 3, the present invention is applicable to the delivery of a Short Messaging Service (SMS) message or a Multimedia Messaging Service (MMS) message. For example, when the SMS message transmission request concerns the emergency or the public operation, the mobile communication terminal 100 can send the SMS message over the access channel of the public frequency band. When it is difficult to send the MMS message only in the access channel, the mobile communication terminal 100 may send the corresponding message using the allocated traffic channel of the public frequency band.

Next, the mobile communication system 300 forwards the SMS message or the MMS message received from the mobile communication terminal 100, to the recipient of the message.

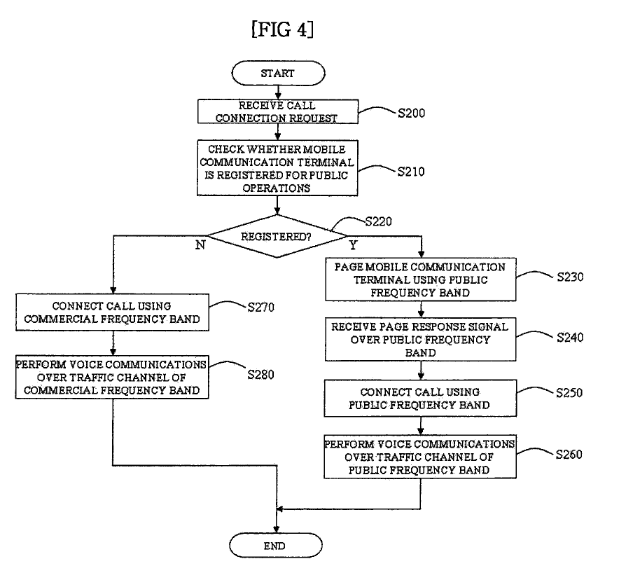

Now, the mobile communication terminal for the public operations is used as the recipient terminal in FIG. 4.

Upon receiving the call connection request for the mobile communication terminal 100 from the sender terminal (not shown) (S200), the mobile communication system 300 checks the current location of the mobile communication terminal 100 and checks whether the mobile communication terminal 100 is registered for the public operations by referring to the HLR 330 (S210).

When the mobile communication terminal 100 is registered for the public operations (S220-Y), the mobile communication system 300 pages the corresponding mobile communication terminal 100 over a paging channel of the public frequency band (S230). Upon receiving a page response signal from the mobile communication terminal 100 over the access channel of the public frequency band (S240), the BTS 310 allocates a traffic channel (the downlink channel and the uplink channel) of the public frequency band to the corresponding mobile communication terminal 100. The MSC 320 performs the remaining call connection procedure to connect the call between the sender terminal and the mobile communication terminal 100 (S250).

The BTS 310 performs the voice communications with the mobile communication terminal 100 over the traffic channel of the public frequency band (S260). Hence, the user of the mobile communication terminal 100 can make the voice communications with the user of the sender terminal (not shown).

By contrast, when the mobile communication terminal 100 is not registered for the public operations (S220-N), the mobile communication system 300 can execute the call connection procedure using the paging channel, the access channel, and the traffic channel of the commercial frequency band (S270). When the call is connected, the mobile communication terminal 100 and the BTS 310 can conduct the voice communications over the traffic channel of the commercial frequency band (S280).

While the voice communications are conducted between the BTS and the mobile communication terminal using the public frequency band in FIG. 4, the present invention is applicable to the delivery of an SMS message or an MMS message. For example, the MSC 320, receiving the SMS message from the sender terminal (not shown), can check whether the corresponding mobile communication terminal 100 is registered for the public operations. When the mobile communication terminal 100 is registered for the public operations, the BTS 310 can send the SMS message through the access channel of the public frequency band. When it is difficult to send the MMS message only in the access channel, the BTS 310 may send the corresponding message by allocating the traffic channel of the public frequency band.

Meanwhile, even when the mobile communication terminal 100 is not registered for the public operations, the mobile communication system 300 can use the public frequency band unless it affects the public operational communications. That is, the mobile communication system 300 can preset to use part of the public frequency band only for the public operational communications, and to use the other public frequency band unless it affects the public operational communications, similar to the commercial frequency band. When the public operational communications increases, the mobile communication system 300 may control not to use the public frequency band for the non-public operations.

So far, the public frequency band is used for the call connection or the message delivery between one sender and one recipient. According to various exemplary embodiments of the present invention, the public frequency band can be utilized for various mobile communication services such as data communication service. The public frequency band may be used for the call connection or the message delivery between multiple senders and multiple recipients.

As set forth above, it is possible to stably connect the call to the public institution in case of the emergency or the public operation. By raising the utilization of the limited frequency resources, the insufficient frequency in the private mobile telecommunication can be addressed. The public institutions provide the public frequency to the private telecommunication companies and use the mobile communication service for free or at a low cost in return. The employees of the public institution can conveniently handle the public operations by means of the single mobile communication terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile telecommunication service method using a public frequency, comprising:
receiving a call connection request for a certain recipient from a mobile communication terminal; and
connecting a radio interval between the mobile communication terminal and a Base station Transceiver Subsystem (BTS) of a call connection interval of the mobile communication terminal and the certain recipient, using a public frequency band.

2. The mobile telecommunication service method of claim 1, further comprising:
authorizing the mobile communication terminal to use the public frequency band,
wherein, when the authorization fails, the radio interval of the mobile communication terminal and the BTS is connected using a commercial frequency band.

3. The mobile telecommunication service method of claim 2, wherein the authorization is performed when the mobile communication terminal is registered for public operations or when the recipient is a public institution.

4. The mobile telecommunication service method of claim 1, wherein the call connection request of the mobile communication terminal is made through the public frequency band.

5. The mobile telecommunication service method of claim 4, wherein the call connection request through the public frequency band is made when the mobile communication terminal is registered for public operations, when an emergency button of the mobile communication terminal is selected, or when the recipient is a public institution.

6. The mobile telecommunication service method of claim 1, further comprising:
charging a fee for the call using the public frequency band for nothing or at a preset discount rate.

7. A mobile telecommunication service method using a public frequency, comprising:
receiving a call connection request for a mobile communication terminal from a certain sender; and
connecting a radio interval between the mobile communication terminal and a Base station Transceiver Subsystem (BTS) of a call connection interval of the mobile communication terminal and the sender, using the public frequency band.

8. The mobile telecommunication service method of claim 7, further comprising:
authorizing the mobile communication terminal to use the public frequency band,
wherein, when the authorization fails, the radio interval of the mobile communication terminal and the BTS is connected using a commercial frequency band.

9. The mobile telecommunication service method of claim 8, wherein the authorization is performed when the mobile communication terminal is registered for public operations or when the sender is a public institution.

10. The mobile telecommunication service method of claim 7, further comprising:
charging a fee for the call using the public frequency band for nothing or at a preset discount rate.

11. A mobile telecommunication service method using a public frequency, comprising:
receiving one of a Short Messaging Service (SMS) message and a Multimedia Messaging Service (MMS) message from a mobile communication terminal over a public frequency band; and
forwarding the received message to a recipient.

12. The mobile telecommunication service method of claim 11, further comprising:
receiving a transmission request for one of an SMS message and an MMS message destined for a mobile communication terminal; and
sending the message to the mobile communication terminal over the public frequency band when the mobile communication terminal is registered for public operations.

13. A mobile telecommunication service system using a public frequency, comprising:
a Base station Transceiver Subsystem (BTS) for wirelessly communicating with a mobile communication terminal; and
a Mobile Switching Center (MSC) for, when receiving a call connection request for a certain recipient from the mobile communication terminal, controlling to use an allocable channel of a public frequency band as a radio interval between the mobile communication terminal and the BTS of a call connection interval of the mobile communication terminal and the recipient.

14. The mobile telecommunication service system of claim 13, further comprising:
an authorizing means for authorizing the mobile communication terminal to use the public frequency band,
wherein, when the authorization fails, the MSC controls to use an allocable channel of a commercial frequency band as the radio interval between the mobile communication terminal and the BTS.

15. The mobile telecommunication service system of claim 13, wherein the call connection request of the mobile communication terminal is made over the public frequency band.

16. The mobile telecommunication service system of claim 15, wherein the call connection request through the public frequency band is made when the mobile communication terminal is registered for public operations, when an emergency button of the mobile communication terminal is selected, or when the recipient is a public institution.

17. The mobile telecommunication service system of claim 14, wherein, when receiving a call connection request for the mobile communication terminal from a certain sender, the MSC controls to use an allocable channel of a public frequency band as a radio interval between the mobile communication terminal and the BTS.

18. The mobile telecommunication service system of claim 17, wherein the authorization is performed when the mobile communication terminal is registered for public operations, when the sender is a public institution, or when the recipient is a public institution.

19. The mobile telecommunication service system of claim 13, wherein the BTS receives one of a Short Messaging Service (SMS) message and a Multimedia Messaging Service (MMS) message from the mobile communication terminal over a public frequency band, and
the MSC forwards the received message to a recipient.

20. The mobile telecommunication service system of claim 13, wherein the MSC receives a transmission request for one of an SMS message and an MMS message destined for a mobile communication terminal, and
the BTS sends the message to the mobile communication terminal over the public frequency band when the mobile communication terminal is registered for public operations.
